(19) United States
(12) Patent Application Publication
(10) Pub. No.: US 2008/0176987 A1
(43) Pub. Date: Jul. 24, 2008

(54) SYSTEM AND METHODS FOR MODIFIED RESIN AND COMPOSITE MATERIAL

(76) Inventors: Fred W. Trevet, Gilbert, AZ (US); Jan Harper-Trevet, Gilbert, AZ (US); Mary A. Mahler, Tucson, AZ (US); Susan Robitaille, Walnut Creek, CA (US); Robert A. Gray, Blue Ash, OH (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 12/018,139

(22) Filed: Jan. 22, 2008

Related U.S. Application Data
(60) Provisional application No. 60/885,986, filed on Jan. 22, 2007.

(51) Int. Cl. C08K 3/34

(52) U.S. Cl. 524/447; 524/445

(57) ABSTRACT

A system for modified resin and composite material and methods therefor generally comprise a plurality of clay nanoparticles dispersed in a high temperature resin to provide enhanced microcrack resistance and maintenance and/or improvement of thermal and mechanical properties. In one embodiment, the invention further comprises a reinforcement disposed in the modified resin, wherein the reinforcement and modified resin together comprise a composite material.

### BACKGROUND OF INVENTION

Composite materials are used in various applications that require integrity of thermal and mechanical properties at high temperatures, including radomes, aircrafts, high speed airframe components and missiles. Conventional composite materials that use high temperature resins as a matrix material have generally fallen short of this requirement. This is due in large part to the stress composite materials undergo during processing. Specifically, during the processing stage of composite materials, matrix resins generally undergo curing and/or heating, and the thermal expansion and contraction of the resin leaves it susceptible to microcracking.

Microcracking is a phenomenon that may occur during the processing stage of composite materials and/or at various temperatures during operation of composite material applications. This cracking negatively affects the mechanical properties of the high temperature resin, including its load bearing capacity. This in turn affects the load bearing capacity of the composite material, resulting in a composite that can only carry light loads. In addition, the cracks provide a path for moisture intrusion, reduce the glass transition temperature (Tg) of the high temperature resin, and negatively affect other thermal and mechanical properties of the high temperature resin.

Prior art attempts to prevent or reduce the microcracking have generally also lowered the Tg, thus lowering the operating temperature, and have also resulted in moisture intrusion which in turn also negatively affects the mechanical properties of the resin. For example, soft rubber particles have been added to the high temperature resin. However, while the rubber particles can absorb some of the strain that occurs during processing and operation, toughening the material, the particles also lower the Tg and thus the operating temperature of the high temperature resin. Other prior art attempts have aimed at altering the processing stage of the composite material to increase the length of the heatup and cool down cycles, but these have resulted in minimal success.

The present invention seeks to solve the high temperature resin microcrack problem without substantially reducing the Tg or substantially increasing the effects of moisture on the high temperature resin's mechanical properties.

### SUMMARY OF THE INVENTION

A system for modified resin and composite material and methods therefor generally comprise a plurality of clay nanoparticles dispersed in a high temperature resin to provide enhanced microcrack resistance and maintenance and/or improvement of thermal and mechanical properties. In one embodiment, the invention further comprises a reinforcement disposed in the modified resin, wherein the reinforcement and modified resin together comprise a composite material.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a modified resin;

FIGS. 2A-B representatively illustrate a modified resin;

FIGS. 3A-B representatively illustrate a modified resin;

FIG. 4 representatively illustrates a modified resin;

FIG. 5 representatively illustrates a modified resin;

FIG. 6 representatively illustrates a modified resin and composite material;

FIG. 7 representatively illustrates a modified resin and composite material;

FIG. 8 representatively illustrates a radome comprising a modified resin; and

FIG. 9 representatively illustrates a radome comprising a modified resin on an aircraft structure.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of elements configured to perform the specified functions and achieve the various results. For example, the present invention may employ various resins, nanoparticles, reinforcement structures, composite materials and the like, which may carry out a variety of functions, in addition, the present invention may be practiced in conjunction with any number of composite materials, and the system described is merely one exemplary application for the invention. Further, the present invention may employ any number of conventional techniques for manufacturing resin, nanoparticles, composite materials, and the like.

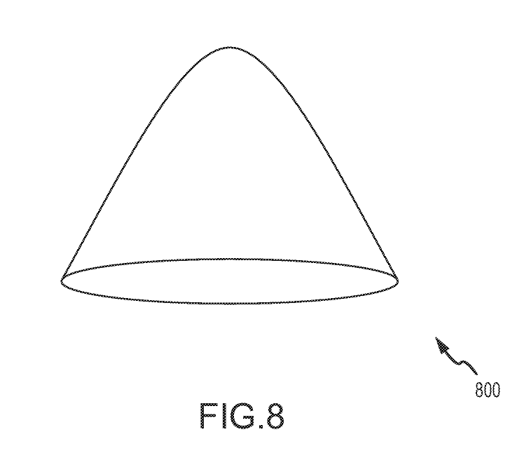

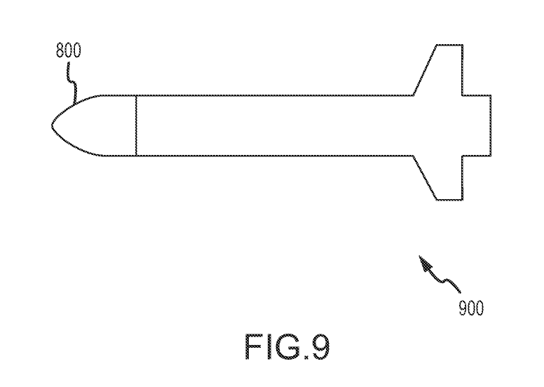

Methods and apparatus according to various aspects of the present invention may be implemented in conjunction with structures exposed to high temperatures. For example, the various embodiments may comprise aircraft structures, such as a radome for a high-speed aircraft, high-speed missile, a leading edge of an aircraft wing, a structural missile component, an external surface of a rocket or satellite, and the like. In the present embodiment, referring to FIGS. 8 and 9, the aircraft structure 900 comprises a radome 800 for a high-speed aircraft. The radome 800 is a structural, weatherproof element defining an enclosure protecting one or more antennae. The radome 800 suitably comprises a material that facilitates transmission of electromagnetic signals between the antenna inside the radome and outside equipment. The apparatus may comprise, however, any appropriate aircraft element or other structure, such as a structure that must maintain structural integrity while exposed to high temperatures.

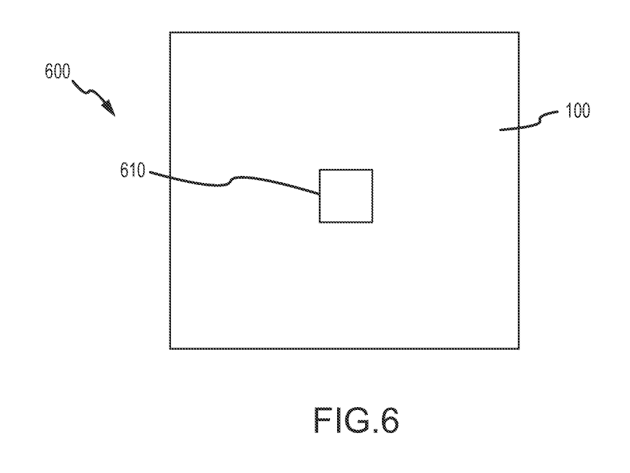

In one embodiment of the present invention, referring now to FIG. 6, the structural material comprises a composite material 600 that may be implemented into an aerospace application, including a high speed missile radome, a leading edge on a wing of an aircraft a high speed airframe component, and a leading edge on a wing or fin of a missile. In another embodiment, the composite material 600 aids the use of low weight, high strength parts for missiles and other projectiles, which are capable of enduring high speeds and high temperatures. In yet another embodiment, the composite material 600 may comprise a more economical and/or more efficient alternative to pyroceram parts in aerospace applications.

Other applications may include use of a modified polymer resin as a multifunctional material structure as part of a composite in a thermal protection system. In one embodiment, the structural material may further provide thermal protection properties. In another embodiment, the structural material comprising thermal properties may reduce and/or eliminate the need for additional thermal protection system materials that are known to contribute weight, but provide substantially no structural function.

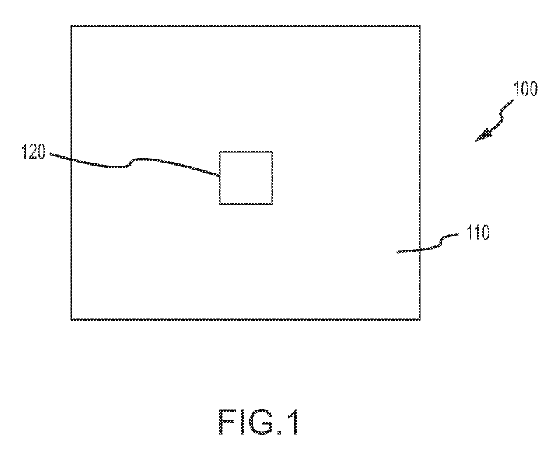

The structural element comprises any suitable materials and elements for maintaining structural integrity while exposed to high temperatures. Referring now to FIGS. 1 through 4, the present radome comprises a modified resin 100, including a main resin and dispersed particles. The main resin 110 comprises a material that is initially relatively viscous and hardens with treatment and/or time. The dispersed particles comprise particles dispersed into the resin to achieve desired properties for the resulting modified resin 100. The radome may comprise the modified resin 100 as a main material, or the radome may comprise a material into which the modified resin 100 is incorporated, such as a composite material 600 having reinforcement 610 integrated into the modified resin 100 as a matrix.

The main resin 110 and the dispersed particles may comprise any appropriate materials for the particular application or environment. In various embodiments, the modified resin 100 comprises a high temperature resin 110 and clay nanoparticles 120 dispersed in the high temperature resin 110. The modified resin 100 may be configured to operate at temperatures up to 950° F., but may be able to operate for intermittent short periods at temperatures as high as 1400° F. Further, the modified resin 100 is substantially microcrack resistant while comprising similar and/or improved thermal and mechanical properties relative to the main resin 110.

The main resin 110 provides the main structural material for the aircraft element. The main resin 110 may comprise any suitable resin for operation at high temperatures, such as high-temperature composite resins having high strength at high temperatures. Further, the main resin 110 may comprise any suitable characteristics such as tensile strength, ductility, dimensional stability, temperature resistance, glass transition temperature, melt points, brittleness, strength and hardness for high strength at high temperatures. For example, in various embodiments where the main resin 110 includes PN, normalized compression strength at 900° F. is maintained at about 39.6 kilopounds per square inch (ksi). Normalized compression modulus for PN at 900° F. is about 3.9 millions of pounds per square inch (msi). Further, interlaminar shear strength for PN at 900° F. is about 2.9 kis.

The main resin 110 may comprise polyimide, bismaleimide, phthalonitrile (PN), epoxy, or a similar resin. The high temperature resin may comprise an organic polymer, and may further comprise a highly cross-linked organic polymer. In one embodiment, the high temperature resin 110 comprises phthalonitrile (PN). In another embodiment, the high temperature resin 110 comprises meta-phthalonitrile (MPN) and/or para-phthalonitrile (PPN).

Any material(s) may be added to the main resin 110 to make it more workable, such as to make it easier to mold, shape, machine, or cure.

The clay nanoparticles 120 are dispersed into the main resin 110 to improve the thermal and mechanical properties of the modified resin 100. For example, the inclusion of the clay nanoparticles 120 into the main resin 110 may reduce the susceptibility of the modified resin 100 to microcracking and at least maintain if not improve the thermal and mechanical properties of the main resin 110.

The clay nanoparticles 120 may comprise any suitable material for dispersal in the main resin 110, where the clay nanoparticles 120 comprise a low interlaminar strength and/or that preferentially shears, slips, or otherwise deforms before the main resin 110 does. For example, the clay nanoparticles 120 may comprise natural and/or synthetic clays exhibiting plasticity through a variable range of water content, and which can be hardened when dried, heated, or otherwise treated. Clay materials generally exhibit lower shear, slip, or other deformation properties than the partially or fully cured high temperature resin and therefore preferentially shear, slip, or otherwise deform instead of the resin.

In various embodiments, the clay nanoparticles 120 may comprise allophone, quartz, feldspar, zeolites, iron hydroxides, illite, kaolinite, dickite, halloysite, nacrite, pyrophyllite, talc, vermiculite, sauconite, saponite, nontronite, montmorillonite, carbon, graphite, exfoliated graphite flakes, layered silicates, fumed silica, aluminum silicates, mica, Pyrograf III, Cloisite, Nanomer, and other similar materials. In various alternative embodiments, the clay nanoparticles 120 comprise montmorillonite nanotubes, Pyrograf III, vapor grown carbon nanofibers, exfoliated graphite flakes, layered silicates, and fumed silica.

The clay nanoparticles 120 may exhibit any appropriate size. For example, nanoparticles have at least one dimension that is, on average, about 100 nanometers (nm) or less. Fewer than ail of the dimensions, however, of the nanoparticles 120 may be about 100 nm or less. For example, nanotubes or nanofibers may exhibit a length of more than 100 nm, such as in the micron range or larger, as long as another dimension, such as the diameter or width of the nanotube or nanofiber, is about 100 nm or less. Likewise, a nanoflake may have one or more dimensions larger than 100 nm, such as in the micron range or larger, as long as one dimension, such as the flake thickness, is about 100 nm or less.

The dimensions of the clay nanoparticles 120 may affect the shear, slip, or other deformation properties of the clay particles 120. For example, the clay nanoparticle 120 size may be tailored such that the shear, slip, or other deformation properties of the clay nanoparticle 120 are comfortably below the shear, slip, or other deformation properties of the main resin 110, ensuring that the nanoparticles 120 deform before the main resin 110 does.

Nanoparticles 120 may be useful because the small size of the particles may allow small stresses to be absorbed by the nanoparticles 120 instead of the resin 110, thereby preventing small microcracks that may otherwise occur at low stresses.

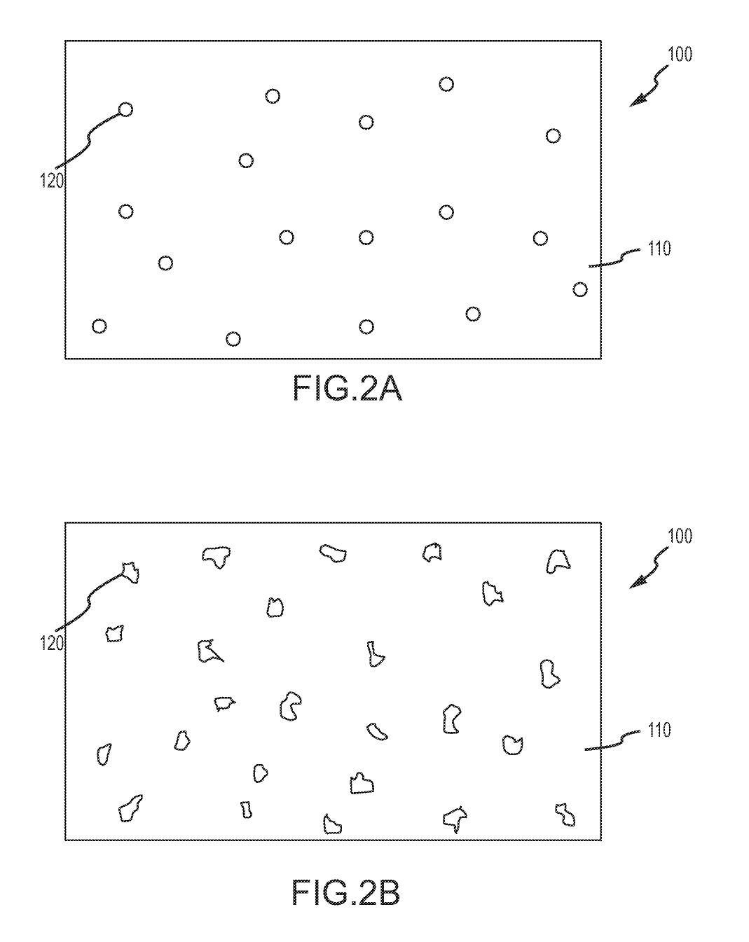

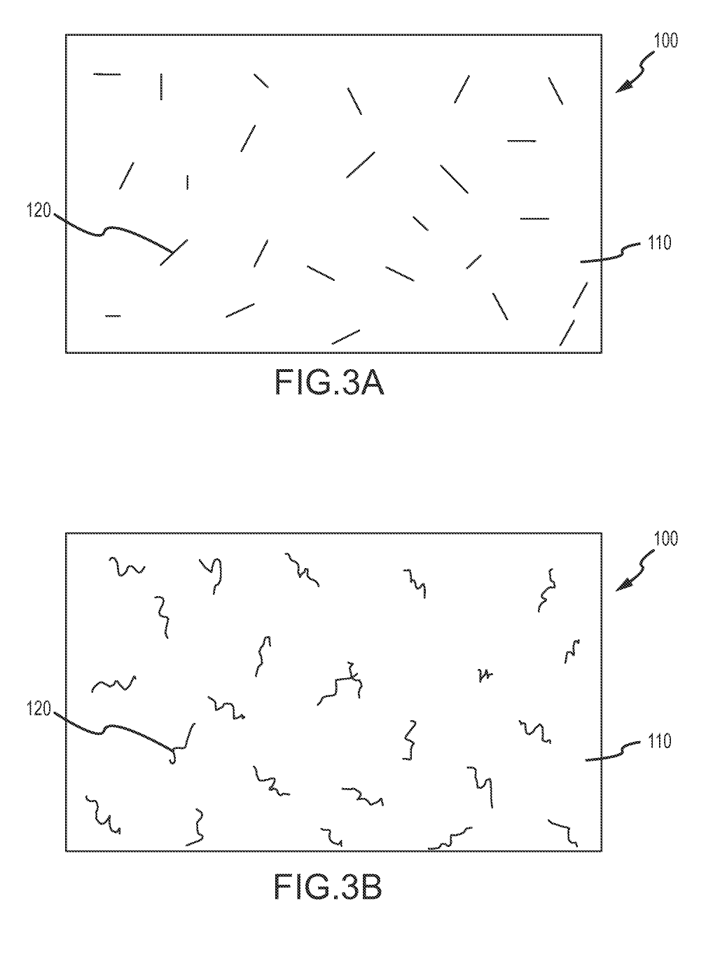

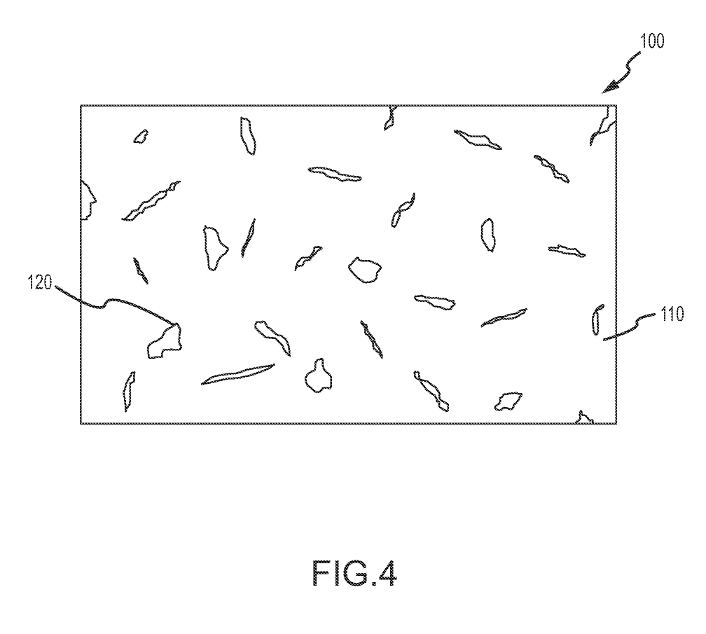

The clay nanoparticles 120 may comprise any suitable shape, such as approximately spherical, tubular, fibrous, flake, flat or irregular. For example, referring now to FIG. 2, the clay nanoparticles 120 could comprise a substantially spherical shape, as seen in FIG. 2A, or the clay nanoparticles 120 could comprise an irregular shape, as seen in FIG. 2B. Referring now to FIG. 3, the clay nanoparticles 120 may comprise nanofibers or nanotubes, in which case the nanofibers or nanotubes could be substantially linear as depicted in FIG. 3A, or they may be at least partially nonlinear, as depicted in FIG. 3B. In an embodiment where nanofibers or nanotubes are used, the nanofibers or nanotubes may comprise be short and/or continuous structures, and the structures could be monofilament or multifilament structures. The clay nanoparticles 120 could also comprise a flake or chip shape, as is representatively illustrated in FIG. 4.

The clay nanoparticles 120 could comprise any other regular shape, such as a cylinder, cuboid, rod, etc., or any irregular shape. In one embodiment, the shape of the clay nanoparticle 120 may affect the crack reduction in the high temperature resin 110. In applications where the stresses causing the microcracks are substantially multidirectional, the shape of the clay nanoparticle 120 might not be as important, and the shape might be chosen based on ease or cost of manufacturing. In addition, the shape of the clay nanoparticles 120 might affect the ease with which they can be dispersed in the high temperature resin 110, and in such a case the clay nanoparticle 120 shape can be altered to ease dispersion in the high temperature resin 110.

The main resin 110 may comprise any appropriate amount of the clay nanoparticles 120. In one embodiment the modified resin 100 comprises about 1-10 weight percent clay nanoparticles 120. In another embodiment, the modified resin 100 comprises about 1-5 weight percent clay nanoparticles 120. Increasing the weight percent of clay nanoparticles 120 can increase the amount of microcracks that can be prevented. However, increasing the weight percent of clay nanoparticles 120 too much might also have adverse effects such as increased material costs, reduced workability of the high temperature resin 120 during the processing stage, decreased strength of the bond between the high temperature resin 110 and a reinforcement 610, clumping of clay nanoparticles 120, altered processing/curing times, etc.

The clay nanoparticles 120 may be oriented randomly or ordered in some organized fashion within the high temperature resin 110. For example, in an embodiment comprising nanofibers or nanotubes, the nanofibers or nanotubes may be oriented unidirectionally, multidirectionally, and/or randomly. In an embodiment comprising nanofibers or nanotubes, the nanofibers or nanotubes may be woven and/or braided. The clay nanoparticles 120 may further be evenly distributed throughout the high temperature resin 110, or there may be varying concentrations of the clay nanoparticles 120 in different portions of the high temperature resin 110. The clay nanoparticles 120 may be organized such that they are substantially isolated from one another, or organized such that there is some grouping of clay nanoparticles 120 into couples or clusters.

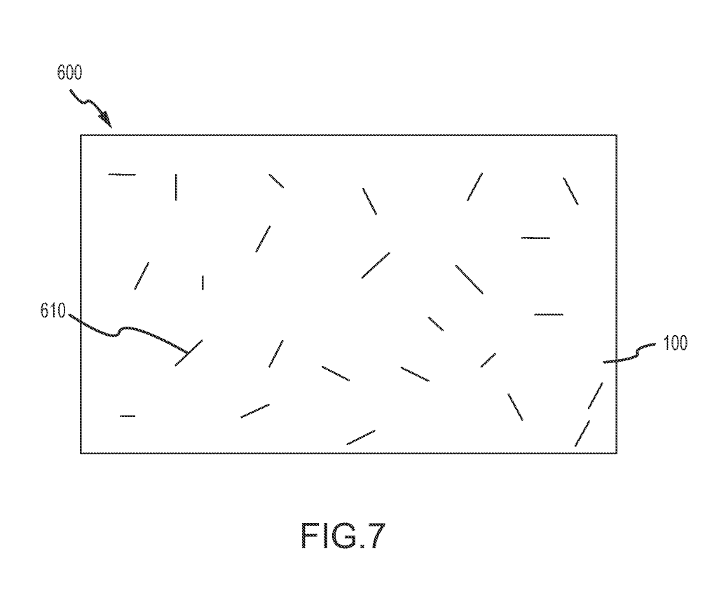

The modified resin 100 may combined with a reinforcement 610 and may be formed into a desired item, such as the radome, or the modified resin 100 may be further modified or integrated into other materials. For example, referring now to FIG. 6, the radome may comprise a composite material 600 including a reinforcement 610 disposed in the modified resin 100, such that the reinforcement 610 and modified resin 100 together comprise a composite material 600. Referring to FIG. 7, an exemplary composite material 600 may include reinforcement 610 comprising fibers. The reinforcement 610 may be unidirectional multidirectional, and/or randomly oriented. Further, the reinforcement 610 may comprise short pieces, continuous pieces, or one continuous piece, and may be further configured to be woven, stitched, and/or braided.

The reinforcement 610 may comprise any composite reinforcement material, such fibers, including glass, carbon and/or quartz fibers, whiskers, filaments, fabric, tow, and the like. For example, the reinforcement 610 may comprise filaments such as aramid, boron, SiC, Al₂O₃, or other suitable composite reinforcement material. Fabric reinforcement materials may comprise fiberglass, quartz, fused silica, or other appropriate reinforcing fabric material. In other embodiments, the reinforcement 610 may comprises tow material such as carbon, organic, glass, metal, or ceramic fibers, or other appropriate tow material.

The modified resin 100 may exhibit improved properties over the main resin 110 alone, such as substantially maintaining and improving the glass transition temperature (Tg) and/or shear strength. For instance, in one embodiment, the modified resin 100 comprises meta-phthalonitrile and clay nanoparticles 120 and the 1000° F. shear strength is 984 psi, as opposed to 880 psi for the 1000° F. shear strength of the meta-phthalonitrile resin without clay nanoparticles 120. In one embodiment, meta-phthalonitrile has a glass transition temperature (Tg) of 269.57° C. without clay nanoparticles 120 and a Tg of 306.88° C. with clay nanoparticles 120. In another embodiment, a high temperature resin comprising 50% para-phthalonitrile and 50% meta-phthalonitrile has a Tg of 277.93° C. without clay nanoparticles 120 and a Tg of 327.71° C. with clay nanoparticles 120. The clay nanoparticles 120 used to obtain these results include montmorillonite, Nancor Corporation 130E and Triton Corporation Clays AS4-35A, AS4-35B. MAV9-65, and MAV7-170.

Further, the presence of the nanoparticles 120 enhances in the high temperature resin 110 provides a higher Tg for the modified resin 100. Additionally, the modified resin 100 shows maintenance, and even in some cases enhancement of shear strength at high temperatures (including temperature up to 1000° F.) when compared to the high temperature resin 110.

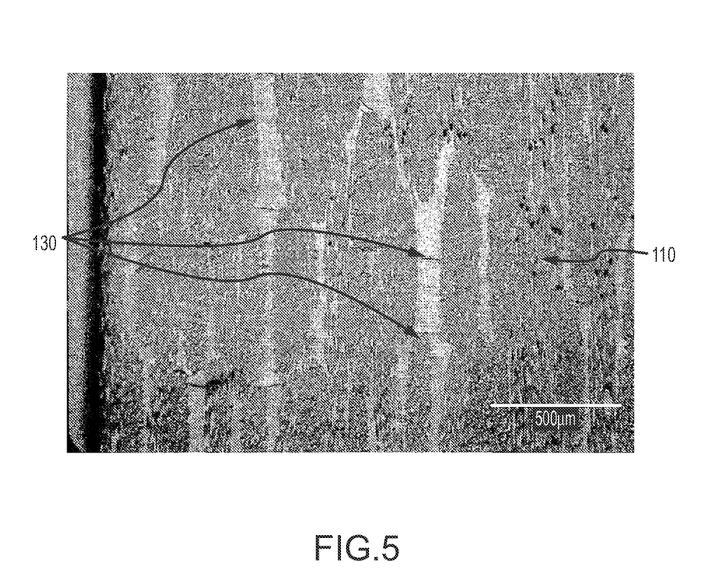

Further, the modified resin 100 may show a reduction of microcracking during processing and/or operating stages as compared to the high temperature resin 110. Referring now to FIG. 5, a high temperature resin 110 without the addition of clay nanoparticles 120 forms microcracks due to CTE adjustment during processing and/or operating stages. By contrast, the modified resin 100 reduces microcracking by the preferential shear, slip along slip planes, or other deformation within the clay nanoparticles 120 instead of deformation within the high temperature resin 110 during the processing or operating stages. The inherently low shear, slip or other deformation properties of the clay nanoparticles 120 provides a mechanism for the high temperature resin 110 to dimensionally adjust due to CTE changes during processing or operation substantially without forming microcracks, thereby retaining and/or improving the mechanical properties of the high temperature resin 110 during operation.

The element comprising the modified composite 100 may be created in conjunction with any appropriate fabrication processes, such as conventional processes involving materials preparation, impregnation, application to reinforcement structures, curing, molding, and the like. For example, in one embodiment, the clay nanoparticles 120 are initially dispersed into the main resin 110 to form the clay reinforced modified resin 100. If the final material is to be a composite, the reinforcement 610 may coupled to or otherwise integrated into the modified resin 100. The process may further include other processes, for example to remove solvents in the modified resin 100 and/or to shape or cure the resulting materials and elements.

For example, the clay nanoparticles 120 may be dispersed in the main resin 110 at and/or before the processing stage. The processing stage comprises a curing stage and/or any other step taken to harden the resin. The clay nanoparticles 120 may be dispersed in the main resin 110 in conjunction with any appropriate method or system for dispersing the clay nanoparticles 120. For example, the clay nanoparticles 120 may be dispersed in the main resin 110 using a method such as solution mixing and the like. Likewise, the clay nanoparticles 120 may be dispersed into the main resin 110 using solvents that are compatible with the main resin 110. The solvents may soften or liquidize the main resin 110 to permit the main resin 120 to receive the clay nanoparticles 120 and/or otherwise permit the main resin 110 to be manipulated.

Prior to curing, the main resin 110 may be dry or wet. Likewise, the clay nanoparticles 120 may be in wet or dry form. In dry form, the main resin 110 particles and/or clay nanoparticles 120 may be combined with another material. For example, the additional material may comprise a binder to hold the particles in close proximity with one another, such as before and/or during a processing stage.

In wet form, the main resin 110 particles and/or clay nanoparticles 120 may be combined with another material, such as a solvent. The solvent may solubilize the main resin 110 and/or clay nanoparticles 120. The solvent may comprise a single solvent or multiple solvents, and heat may be applied to further solubilize the main resin 110 particles and/or clay nanoparticles 120 in the solvent.

For example, the main resin 110 may comprise solid phthalonitrile in powdered form. Alternatively, the main resin 110 may comprise a wet phthalonitrile resin. In one embodiment, dimethylformamide (DMF) or N-Methylpyrrolidone (NMP) is used at temperatures over 50° C. to solubilize the main resin 110 particles and/or clay nanoparticles 120.

Other solvents, however, may be utilized, such as methyl ethyl ketone (MEK) or a combination of NMP and MEK. In another embodiment, the main resin 110 comprises meta-phthalonitrile and is solution coated in cyclopentatone and DMF with the high temperature resin 110 content being around 36±3%. In yet another embodiment, the main resin 110 comprises para-phthalonitrile and is solution coated in NMP with the high temperature resin 110 content being around 36±3%. In another embodiment, a mixture of 50% para-phthalonitrile and 50% meta-phthalonitrile are solution coated in NMP with the high temperature resin 110 content being about 36±3%. Other solvents, such as acetone or toluene, might also be used.

For embodiments in which the modified resin 100 is part of a composite material 600, the modified resin 100, or the main resin 110 and the clay nanoparticles 120, may be combined with the reinforcement 610 to form the composite material 600. For example, the reinforcement 610 and the modified resin 100 may be combined to form a preimpregnated composite (prepreg or preform), such as towpreg. The impregnation may be accomplished by any suitable method such as mechanical combination, commingling, solvent impregnation, melt impregnation, powder impregnation, and the like. For example, in one embodiment dry clay nanoparticles 120 are dispersed in phthalonitrile resin 110, and the modified phthalonitrile resin is then solidified and combined with fiber unitape, tow, fabric, and/or fabric preforms to form a powdered prepreg. In yet another embodiment, dry clay nanoparticles 120 are dispersed in wet phthalonitrile resin, and the modified phthalonitrile resin is then combined with fiber unitape, tow, fabric, or fabric preforms to form a prepreg. In an embodiment where a prepreg is not formed, the reinforcement 610 and modified resin 100 can be combined to form the composite material 600 using any suitable method, such as mechanical mixing, solution mixing, vacuum infusion, resin transfer molding and the like.

The modified resin 100 or the composite material 600 may be further processed. For example, heat or additional chemicals may be applied to cure the modified resin 100. Any suitable cure temperature, cure chemical, time, cycle, pre-cure, post-cure, or other appropriate process or material may be used. In one embodiment, the cure process comprises a cure temperature of 615° F. and a post-cure temperature of 715° F.

The article may be formed from the modified resin 100 or the composite material 600. For example, the composite material 600 and/or prepreg may be formed into a final shape and/or structure using any suitable method, such as filament winding, weaving, compression molding, vacuum bag processing, matched die molding, pressure bag processing, resin transfer molding, vacuum assisted resin transfer molding (VARTM), autoclave molding, and the like. The consistency, texture, and/or viscosity of the modified resin 100 may be varied by any appropriate method to facilitate formation of the shape of the composite material 600. For instance in one embodiment, the modified resin 100 comprises an MVK-3 phthalonitrile resin transfer molding (RTM) resin, the reinforcement 610 comprises glass fibers, and resin transfer molding is used to form the composite material 600 into its desired shape.

The clay nanoparticles 120 may be dispersed in the main resin 110 in solvent, then the mixture is used to coat a fabric, after which the solvent is removed, leaving a dry impregnated fabric which is then cured by compression molding. In another embodiment, the clay nanoparticles 120 are dispersed in the main resin 110 in solvent, the solvent is removed, and then the modified resin 100 is applied to a fiber/fabric preform using resin transfer molding. In other embodiments, hand-wet-out impregnated fabrics are formed using meta-phthalonitrile, para-phthalonitrile, and/or mixtures of meta-phthalonitrile and para-phthalonitrile in any suitable ratio. In one embodiment, the resin 110 comprises an approximate 50/50 mixture of meta-phthalonitrile and para-phthalonitrile.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation of such terms, refer to a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A modified resin, comprising:
a main resin; and
a plurality of clay nanoparticles dispersed in the main resin.

2. A modified resin according to claim 1, wherein the modified resin comprises about 1-10 weight percent clay nanoparticles.

3. A modified resin according to claim 1, wherein the main resin comprises at least one of a dry powder, a liquid, and a highly crosslinked organic polymer.

4. A modified resin according to claim 1, wherein the main resin comprises phthalonitrile (PN).

5. A modified resin according to claim 1, wherein the clay nanoparticles comprise nanoflakes.

6. A modified resin according to claim 1, wherein the clay nanoparticles comprise at least one of allophone, quartz, feldspar, zeolite, iron hydroxide, illite, kaolinite, dickite, halloysite, nacrite, pyrophyllite, talc, vermiculite, sauconite, saponite, nontronite, montmorillonite, layered silicates, fumed silica, aluminum silicate, mica, Cloisite, Nanomer, and Pyrograf III.

7. A modified resin according to claim 1, wherein the modified resin is substantially capable of at least one of operating in temperatures up to 950° F. and operating for short, intermittent periods at temperatures up to 1400° F.

8. A modified resin according to claim 1, wherein the clay nanoparticles comprise lower interlaminar shear strength than the main resin to at least one of maintain and improve matrix integrity of the main resin.

9. A modified resin according to claim 1, further comprising:
a reinforcement disposed in the modified resin;
wherein the reinforcement comprises at least one of a fiber, a tow, and a fabric; and
wherein the modified resin and reinforcement form a composite material.

10. A microcrack resistant composite material, comprising:
a modified resin, comprising:
a high temperature phthalonitrile resin; and
a plurality of clay nanoparticles dispersed in the high temperature phthalonitrile resin; and
a reinforcement disposed in the modified resin comprising at least one of fiber, tow, and fabric.

11. A composite material according to claim 11, wherein the modified resin comprises about 1-10 weight percent clay nanoparticles.

12. A composite material according to claim 11, wherein the dry clay nanoparticles comprise at least one of allophone, quartz, feldspar, zeolite, iron hydroxide, illite, kaolinite, dickite, halloysite, nacrite, pyrophyllite, talc, vermiculite, sauconite, saponite, nontronite, montmorillonite, layered silicates, fumed silica, aluminum silicate, mica, Cloisite, Nanomer, and Pyrograf III.

13. A composite material according to claim 11, wherein the dry clay nanoparticles comprise nanoflakes.

14. A composite material according to claim 11, wherein the modified resin is substantially capable of at least one of operating in temperatures up to 950° F. and operating for short intermittent periods at temperatures up to 1400° F.

15. A composite material according to claim 11, wherein the composite material comprises at least one of a prepreg, a towpreg and a fiber unitape.

16. A composite material according to claim 11, wherein the composite material is suitably configured to operate on at least one of a high speed radome, a leading edge on a wing of an aircraft, a high speed airframe component, a leading edge of a fin of a missile, and a leading edge on a wing of a missile.

17. A method for modifying a resin to at least one of substantially maintain and improve glass transition temperature and shear strength of the resin while increasing microcrack resistance, comprising:
dispersing a plurality of clay nanoparticles in a high temperature phthalonitrile resin, wherein the clay nanoparticles comprise about 1-10 weight percent of the high temperature phthalonitrile resin.

18. A method according to claim 17, wherein the modified resin is substantially capable of at least one of operating in temperatures up to 950° F. and operating for short, intermittent periods at temperatures up to 1400° F.

19. A method according to claim 18, further comprising:
disposing the modified resin in a reinforcement;
wherein the reinforcement comprises at least one of a fiber, a tow, and a fabric, and
wherein the modified resin and reinforcement together comprise a composite material.

20. A method according to claim 19, further comprising at least partially forming at least one of a high speed radome, a leading edge of a wing of an aircraft, a leading edge of a fin of a missile, and a leading edge of a wing of a missile with the composite material.
